(19) United States
(12) Patent Application Publication
(10) Pub. No.: US 2015/0363808 A1
(43) Pub. Date: Dec. 17, 2015

(54) GAMIFIED AND/OR REACTIVE CONSUMER INCENTIVES FOR MASS ADOPTION OF CREDIT, CHARGE AND/OR DEBIT CARDS, AND ACCESS TOKENS, USING ONE TIME PASSWORD (OTP) AUTHENTICATION

(71) Applicant: Frank S. MAGGIO, Pinellas Park, FL (US)

(72) Inventor: Frank S. MAGGIO, Pinellas Park, FL (US)

(21) Appl. No.: 14/737,469

(22) Filed: Jun. 11, 2015

Related U.S. Application Data
(60) Provisional application No. 62/011,015, filed on Jun. 11, 2014.

(51) Int. Cl. G06Q 30/02; G06Q 20/40; G06Q 20/38; G06Q 20/34

(52) U.S. Cl. CPC G06Q 30/0212; G06Q 20/341; G06Q 20/409; G06Q 20/385

(57) ABSTRACT

A system and method are provided for enabling a mass audience of network-connected users of computing and mobile communicating devices to employ financial instruments, including credit cards, debit cards or other physical transaction tokens, which are enabled to engage in one-time password (or passcode) (OTP) transaction validation, to participate in contests and sweepstakes as part of the OTP-enabled transaction validation process. The disclosed schemes make use of an emerging technology that allows powered credit cards to generate unique and/or random four or more digit numbers as OTPs. The disclosed schemes gamify the use of these transaction vehicles by awarding prizes for their use. The time sensitive and randomly associated nature of the OTP provides an additional layer of security for the financial transactions. The consumer or customer is not required to memorize, for entry at the point of a transaction.

This application claims priority to U.S. Provisional Patent Application No. 62/011,015 entitled “System and Method for Deployment of Gamified (and Reactive) Consumer Incentives for Mass Adoption of Credit/Charge/Debit Cards Utilizing One Time Password (OTP) Authentication,” by Frank S. Maggio, filed in the U.S. Patent and Trademark Office on Jun. 11, 2014, the disclosure of which is hereby incorporated by reference herein in its entirety.

### BACKGROUND

1. Field of the Disclosed Embodiments

This disclosure relates to systems and methods for enabling a mass audience of network-connected users of computing and mobile communicating devices to employ financial instruments, including credit cards and debit cards, and physical access transaction tokens, which are enabled to engage in one-time password (or passcode) (OTP) transaction validation, to participate in contests and sweepstakes as part of the OTP transaction validation process.

2. Related Art

The purchasers of goods and services in all types of “monetary” transactions worldwide have continued their migration away from the exchange of actual currency or cash with any merchant or service provider at the point of concluding the ultimate transaction, e.g., the point of sale or payment for services rendered. A 2014 survey in the United States found that some eighty percent of American consumers carry less than fifty dollars in cash on their person at any given time. Overwhelmingly, consumers worldwide have embraced the concept of paying with some manner of “plastic.” Individual consumers and business entities generally carry an array of credit cards, charge cards and/or debit cards, many of which are associated with one or more of the well-known national or international credit card network companies. There is also an increasing proliferation in the use of merchant-specific most credit, charge, pre-paid or debit cards, many of which may be, for example, pre-loaded with specific amounts. Interestingly, even such pre-loading may be charged to one or more of what a particular consumer considers to be his or her “primary” or “principal” credit card account. Other publicly-available survey data generally indicates that an average American household routinely makes use of eight or more credit cards in the conduct of monthly household “business.”

A very lucrative support industry has arisen around facilitating credit card transactions and making it ever easier for consumers or customers to simply “swipe” their credit or debit cards to pay for any good or service at fixed points of sale and/or with mobile merchants and service providers, and to “enter” or “enter and save” credit card payment information when interacting with online retailers. Purchases and payments are made in this manner not only for the simplicity of each transactive event, but also because details of the accumulated transactions are captured and collected in the form of credit card account statements that generally free the consumers or customers from having to collect and catalog individual receipts.

A latest trend in the lucrative world of alternative payment vehicles involves use of a particular consumer's mobile computing and/or communicating device to effect payment for goods purchased or services rendered. A small, but increasing, number of merchants and/or service providers, in addition to making available the now all-too-familiar, and increasingly consumer-friendly, hardware by which a customer may simply swipe his or her credit card, are expanding their capabilities to accept payments using one or more near field communication (NFC) technologies. Additional, or modified, merchant-controlled hardware components are provided to “read” transaction or payment information associated with a particular consumer or customer directly from a NFC-capable transaction component carried by the consumer or customer. Such NFC-capable transaction components may take the form of radio-frequency identification (RFID) chip readers that read RFID chips, which may be embedded in, or affixed to, traditional credit cards to provide information associated with those traditional credit cards. See the discussion of EMV technology implementation below. Such NFC components may also take the form of some image capture reader that reads a visually-discernible mark that a consumer or customer may display by any means including on a display screen of a mobile computing and/or communicating device such as, for example, a tablet or smart phone.

Regardless of the payment vehicle employed by a particular consumer or customer, it is safe to say that the average consumer has little to no insight into, interest in, or familiarity with, the mechanics of the transaction, i.e., how their credit purchases are accepted, recorded, approved, and/or billed to them. The average consumer knows that they present their transaction token, in the form of a plastic card or visually-discernible display on their electronic device, to a cooperating reader at the point of sale and the transaction is recorded and approved. At a routinely-recurring time every month, the average consumer then receives a bill from his or her bank or credit card company, which the consumer then pays all or a portion of to the bank or credit card company.

The average consumer is also generally unaware as to the manner by which the credit card companies and/or participating financial institutions make their money. It is clearly understood, based on a passing familiarity with the terms, and specifically the percentage rates, associated with a particular credit card, that the credit card companies or issuing banks make money based on those percentage rates generally being applied to the credit card holder's unpaid balance. Generally less understood is that there are incremental fees, or carrying charges, associated with each transaction and even myriad steps in a particular transaction executed between a number of participating entities. Each of the customer's bank, the credit card company, and the merchant's bank may exact certain fees for the handling of each transaction. The process is generally transparent to the consumer or customer, but somebody ultimately pays these fees. These embedded costs of doing business will generally, and ultimately, be reimbursed transparently by the consumer population.

Based on the ability to extract transaction fees, even if only a couple of pennies on each transaction, banks and credit card companies aggressively compete for a larger share of the consumer or customer population. Elaborate advertising campaigns inform consumers or customers of the myriad “advantages” that may be realized in acquiring and using the credit cards issued by a particular credit card company, bank or other entity. In this regard, the national and international credit card network companies, as well as credit, charge, stored-value, debit and bank card issuers, are constantly looking for points of differentiation with their competition, in order to increase the use of their instruments over those of their competitors. Ultimately and collectively, those entities in the “credit card space” have conventionally proven limitedly innovative in finding attractive ways to provide certain “incentives” to their consumer or customer users. These incentives form the basis by which the individual card networks and/or issuers seek to entice additional users to their instruments rather than those of their competitors. These incentives include, but are not limited to, such things as frequent flier miles, myriad affinity points or “cash back” promotions, enhanced merchandise return or warranty policies, competitive price protections, and insurance premium payments. The objective is to entice an ever-expanding population of credit card customer users or transactors, often carrying multiple credit/debit cards to make purchases using one entity's card over those of the other entities.

Not only do the card issuers target individual consumer or customer cardholders, or potential cardholders, with their incentivized programs, but the card issuers may also cooperate with merchants and advertisers to provide business incentives for the promotion of the use of their transaction vehicles over those of others. The business incentives may include certain merchant fee adjustments, specially-promoted contests, and expedited payments, to the benefit of individual merchants as reasons for those merchants “favoring” and promoting consumer or customer use of one issuer's card over others.

In the same manner that the unseen transaction fees collected for each transaction may subtly increase consumer costs as the marketplace passes along those fees to the consumers through incremental price increases for goods or services, certain of the incentives introduced by the credit card companies, banks or other card issuers may actually serve ultimately to increase the net costs of the goods and services to consumers. In order to achieve the “incentives,” annual fees may be levied, interest rates may be increased when payments are financed, and/or merchants may pass the merchant banking and other related fees along to consumers, by virtue of including additional “costs of doing business” in the cost of products sold.

Against this backdrop, the advantages provided by the ease with which consumers and customers are able to pay for the goods and services that they buy by simply swiping their credit cards or displaying their account identifying information to a cooperating NFC receiver are offset to a certain extent not only by the incurred costs, but moreover by the vulnerability of such payment methods or transaction vehicles to physical or electronic pickpocketing. When an individual's currency or cash is stolen, the loss is confined to the individual and is limited to the specific amount of currency or cash that the individual carried. Any impact on the overall marketplace is negligible. When credit cards, or credit card data, are stolen or intercepted, losses can be fairly extensive and felt across the marketplace. These losses are often allocated between the merchants, the credit card companies, the credit card networks, the issuing banks, the merchants' banks, insurance companies and the consumers or customers. Ultimately, the marketplace suffers in absorbing and allocating direct and indirect costs/losses incurred when some individual or group, other than the authorized cardholder(s) use a credit card or electronic device to complete a transaction for often significant sums.

Credit card companies and issuers for years have met this threat by developing and implementing increasingly sophisticated identification and differentiation methods by which internal crosschecks are provided on the actual credit card itself, or in the credit card data. An objective of these measures is to limit unauthorized uses of credit card and other electronic payment methods. Certain credit cards include, for example, one or more of the following security features. Repeated and verifiable numbering formats are used. The first four digits of the account number, for example, likely correspond to a Bank Identification Number (BIN) for the issuing credit card company or bank. These four digits may be repeated in other places on a face of the credit card in order to provide a visual crosscheck usable by a merchant accepting the credit card payment. The last four digits of an account number are generally reproduced on the transaction receipt. These four digits may also be reproduced in some other position on, for example, a reverse face of the card in order to provide multiple levels of visual crosscheck to merchant sales personnel. Hologram images, which the merchant sales personnel are trained to recognize, may be included on a face of the credit card. When rotated, such hologram images will reflect the light differently and appear to move in a predictable manner that the merchant sales personnel can verify. Expiration dates are visibly displayed as another manner by which to provide a crosscheck of the authenticity of the particular credit card. A cardholder's name is printed on the face of the card to provide additional means by which to crosscheck information otherwise presented. Signature panels, generally on a reverse side of a credit or debit card, are now printed in a manner that makes them more readily tamper evident. Three digit card security codes are provided, generally as an electronic transaction crosscheck means.

RFID chips, known as EMV chips (for Europay®, MasterCard® and Visa®, the companies that initially developed the increased EMV security standard for use in the 1990's), which are prevalent for use in foreign countries, have recently been introduced into the U.S. marketplace. These visually-distinctive chips may be added to a face of the credit or debit card. These chips provide interactive means by which the credit or debit card may be made to communicate with an issuer's computer servers. This communication can be used to modify, refine and/or reinforce changeable security features associated with the credit or debit card over time. This capability is advertised as an advantage over magnetic stripe cards, which include only static information that can be once read and used to create counterfeit clone cards. The EMV chips provide a limited capacity to remotely modify the security information associated with the card without requiring replacement if unauthorized use is detected and/or verified. Acceptance of these security-enhanced chip card features in the United States has been delayed based on a cost to implement, which is estimated to be greater than $10 billion, mostly attributable to the need to retrofit merchant payment locations with EMV compatible readers.

The above-described security enhancements need to be consistently updated in order to stay one step ahead of the hackers and identity thieves. As each new capability is introduced, these hackers and identity thieves become increasingly sophisticated in their ability to illegally obtain consumer or customer account information despite the security enhancements. The static, or even semi-static, nature of the information presented on a particular transaction instrument, be it a credit card, or an electronic payment display component, makes it ripe for harvesting by the sophisticated identity thief. Moreover, as the credit card space transitions to instruments that do not require physical interaction, but rather are readable with unauthorized NFC readers, security concerns will continue to increase, and additional intervention means will need to be contrived and implemented.

### SUMMARY OF DISCLOSED SUBJECT MATTER

In view of the above background, it is clear that security concerns will continue to evolve as the credit card, or other payment instrumentality, issuers strive to stay one step ahead of the identity thieves. These concerns, combined with the realization that there is very little in the competitive “incentive” efforts employed by those in the credit card and/or electronic payment space to differentiate one from another that is truly novel, and cannot ultimately be fairly easily duplicated by other competing entities, e.g. “extra” miles, or 1% vs. 3% cash back, or the like, provide a unique opportunity to introduce advancing security technology in a manner fosters its use through a unique incentivization scheme.

A powered credit card is being developed that incorporates a technology by which a “One Time Password” (or Passcode, “OTP”) is randomly and temporarily generated at a point in time of the use of the credit card to conclude a particular transaction. The powered credit card and OTP concepts described throughout this disclosure are intended to refer to a class of technologies, systems, methods processes and/or schemes by which credit, charge, debit, and other transaction cards, or other physical tokens for presentation in financial transactions, are able to generate on-demand a four or more character time-sensitive password that is randomly, or pseudo-randomly, associated with the transaction vehicle at the time of transaction. The generating of the OTP may occur upon activation of a button on the powered card, or other transaction token display. The time sensitive and randomly associated nature of the OTP provides an additional layer of security for the financial transactions. The consumer or customer is not required to memorize, for entry at the point of a transaction, any one or more passwords or PIN numbers that are statically, or semi-statically, associated with the transaction instrument.

It would be advantageous to provide systems, methods, schemes and/or processes that may incentivize adoption of OTP-enable transaction instruments in the marketplace.

Exemplary embodiments of the systems and methods according to this disclosure may make advantageous use of the proposed technology allows powered credit cards to generate unique, seemingly random 4-8+ digit numbers (or in the future, symbols, letter, tones, or a combination thereof) as OTPs and gamify the use of such transaction vehicles to the benefit of the marketplace.

In embodiments, consumers and customers, merchants and service providers, and other entities involved in point-of-sale transactions for goods and services, whether at fixed locations, at mobile locations, or over the Internet, may participate in a service that reads all or a portion of the generated-OTP, detached from the payment vehicle with which the OTP is associated, for entry into a periodically-awarded sweepstakes-like prize pool. It is envisioned that the potential reward for use of a particular OTP instrument will drive the marketplace, consumers and merchants alike, to embrace use of the OTP payment vehicle, and potentially a single OTP payment vehicle associated with a particular consumer population, or population segment.

Exemplary embodiments may provide a user of an OTP payment vehicle to activate the OTP display on the payment vehicle to display the randomly, or pseudo-randomly, generated unique, time-sensitive code. The user may then enter that code into a device or data entry window in a payment portal or website to obtain authorization of the transaction in which the OTP payment vehicle is used for payment.

Exemplary embodiments may provide the opportunity for the OTP to be read by, or separately entered into, a gaming program or scheme that is associated with a prize pool. Read or otherwise entered “used” OTPs may be randomly and periodically selected for the award of prizes from the prize pool to a user whose OTP matches the randomly and periodically selected OTP.

Exemplary embodiments may otherwise incentivize use of OTP-enabled transaction vehicles by providing routine rewards to the consumer or customer population using the particular OTP-enabled transaction vehicle in a gamified and/or reactive advertising environment that uniquely encourages consumer, customer, merchant and/or other related entity participation in the scheme.

Exemplary embodiments may collect and analyze consumer or customer trends based on the collected OTPs to provide merchants, advertisers, credit card issuers and other interested entities with feedback.

These and other features, and advantages, of the disclosed systems and methods are described in, or apparent from, the following detailed description of various exemplary embodiments.

### BRIEF DESCRIPTION OF THE DRAWINGS

Various exemplary embodiments of the systems and methods for enabling a mass audience of network-connected users of computing and mobile communicating devices to employ financial instruments, including credit cards, debit cards or other physical transaction tokens, which are enabled to engage in one-time password (or passcode) (OTP) transaction validation, to participate in contests and sweepstakes as part of the OTP transaction validation process, according to this disclosure, will be described, in detail, with reference to the following drawings, in which:

FIG. 1 illustrates a block diagram of an exemplary transactive environment within which the gamified OTP schemes according to this disclosure may be implemented;

FIG. 2A illustrates a block diagram of an exemplary OTP-enabled credit card as an example of an OTP-enabled physical transaction token that is usable in the gamified scheme according to this disclosure;

FIG. 2B illustrates a block diagram of an exemplary OTP-enabled visually-readable display component as an example of an OTP-enabled electronic display device that is usable in the gamified scheme according to this disclosure;

FIG. 3 illustrates a block diagram of an exemplary implementation system than may be housed in a central facility for implementing the gamified scheme according to this disclosure; and

FIG. 4 illustrates a flowchart of an exemplary method for implementing the gamified scheme involving the consumer use of OTP-enabled transaction vehicles according to this disclosure.

### DETAILED DESCRIPTION OF EMBODIMENTS

The systems and methods for enabling a mass audience of network-connected users of computing and mobile communicating devices to employ financial instruments, including credit cards, debit cards or other physical transaction tokens, which are enabled to engage in one-time password (or passcode) (OTP) transaction validation, to participate in contests and sweepstakes as part of the OTP transaction validation process, according to this disclosure will generally refer to these specific utilities for those systems and methods. Exemplary embodiments described and depicted in this disclosure should not be interpreted as being specifically limited to any particular configuration of a transaction vehicle and/or support features, both hardware and software for supporting the use of a transaction vehicle in completing a transaction, including for the purchase of goods or services at one or more of a fixed merchant location, with a mobile goods or services provider or on any electronic network, including the Internet, through which electronic merchants may be accessed. It should be recognized that any advantageous use of the systems and methods for gamifying a transaction based on the presentation of a unique code generated at the time the transaction is made that may benefit from processes, techniques or schemes such as those discussed in detail in this disclosure is contemplated as being included within the scope of the disclosed exemplary systems and methods.

The systems and methods according to this disclosure will be described as being particularly adaptable to use interactions with OTP-enabled transaction vehicles as those transaction vehicles are currently being developed for entry into the commercial marketplace. These specific references are meant to be illustrative only in providing a single real-world utility for the disclosed systems and methods, and should not be considered as limiting the disclosed systems and methods to any particular product or combination of devices, or to any particular type of electronically readable transaction vehicle or scheme supporting the use of such a transaction vehicle. In other words, any commonly-known transaction vehicle that may be modified to be OTP-enabled by incorporating such technology therein or that may be adapted according to the specific capabilities discussed in this disclosure is contemplated.

The disclosed embodiments are intended, among other objectives, to provide a uniquely “incentivized” scheme to support introduction and proliferation of OTP-enabled transaction vehicles in support of achieving additional layers of security for all types of transactions in which the vehicles may be employed.

As described in this disclosure, the term “OTP” is intended to refer generally to a class passwords or authorization codes that are generated by one or more processes, schemes and techniques that use a proprietary, often time-sensitive, “hashed” algorithm to produce the temporary passwords or codes. In embodiments, reference may be made to databases, which contain numbers and passwords that may be deemed “approved” when presented, or, potentially, would be approved in tandem with some or all of the data derivable from the time, date, a portion of a consumer's card number or personal information, or geo-location information of the merchant or consumer at the time that a transaction is made using an OTP-enabled transaction vehicle. Licensed and permissioned parties may have access to the databases for reference and to allow payments to be authorized or rejected. This conventional transaction processes may be provided with a new, more secure layer of authentication that is anticipated to diminish the costs of fraud and theft.

In embodiments, the disclosed schemes will account for anticipated vulnerabilities as hackers and identity thieves attempt to adapt to widespread proliferation of OTP. Those of skill in the relevant art will recognize that no system is foolproof and OTP will remain vulnerable to social engineering attacks in which, for example, “phishers” may acquire (steal) OTPs by tricking consumers into providing one or more OTPs that they have used in the past. Even time-synchronized OTPs may remain vulnerable to phishing via certain methods of attack. The OTP may be recovered and used as quickly by the attacker as the legitimate user, if the attacker can get the OTP in plaintext quickly enough. Further, a sophisticated phisher may use the information gained from, for example, past OTPs that are no longer valid to replicate the generation algorithm in a manner that may allow the phisher to attempt to predict what OTPs will be used in the future. OTPs may generally represent only pseudo-randomization rather than being truly random. It is these pseudo-randomization schemes that may be studied in an effort to replicate them. Man-in-the-middle attacks will remain a concern necessitating that OTPs should still be only limitedly disclosed to, for example, third parties, without first being further hashed. Regardless, using an OTP as one layer in layered security is anticipated to lessen the vulnerability to random attack safer than using OTP alone. For example, combining OTP with a password that is memorized by the user may increase security and using such layered security is implements other password protection while decreasing instances of password fatigue.

The disclosed schemes seek to incorporate OTP as a technology and security platform into an incentivized marketplace. In recent years, there has emerged, in certain business sectors, a consumer or customer trend toward embracing gamification, online games, mobile apps, and games of skill and luck that are electronically enabled, and that themselves provide certain incentives for participation in one over another. A growing number of consumers enjoy numbers-based games of skill and chance, ranging from fantasy football to March basketball brackets to various number-based games of skill or chance including, for example, on-line bingo, poker, lotto and lotteries. Certain affinity point programs by advertisers also attract attention in which numbers and letters may be entered online, and prizes awarded for “correct” participation.

In the mass media advertising space, marketing and programming are being developed around the concept of Reactive advertising. U.S. Pat. No. 6,606,745 (the 745 Patent), entitled “Method and System For Communicating Advertising And Entertainment Content And Gathering Consumer Information,” issued to Frank S. Maggio on Aug. 12, 2003, describes a scheme empowered by Internet-connected smart phones, tablets, and computers, that is poised to change the landscape of advertising and marketing, by infusing ad-attentioning and attention verification, with gamification, contesting, and real-world rewards. In the Reactive process as described in the 745 Patent, promoters and advertisers are able to more fully engage often personally and demographically pre-registered consumers, moving from a Reactive, to an interactive, and ultimately to a transactive process, where a sharing of ideas, feedback, and ultimately commerce results.

The confluence of the above concept resulted in development of the disclosed schemes whereby a positive incentive is provided for merchants and consumers to adopt and embrace the use of OTP credit cards and other OTP transaction vehicles, so that an amount of online theft continues to diminished, a cost of creating OTP-enabled cards, other transaction vehicles and supporting structures diminishes as volume increases, and, ideally, those who promote and facilitate the use of OTP-enabled transaction vehicles become advocates, and increased users of, these specially-enabled transaction vehicles. An objective is to promote mass adoption (and the related positive impacts) in providing further savings and security to transactions in the credit card space.

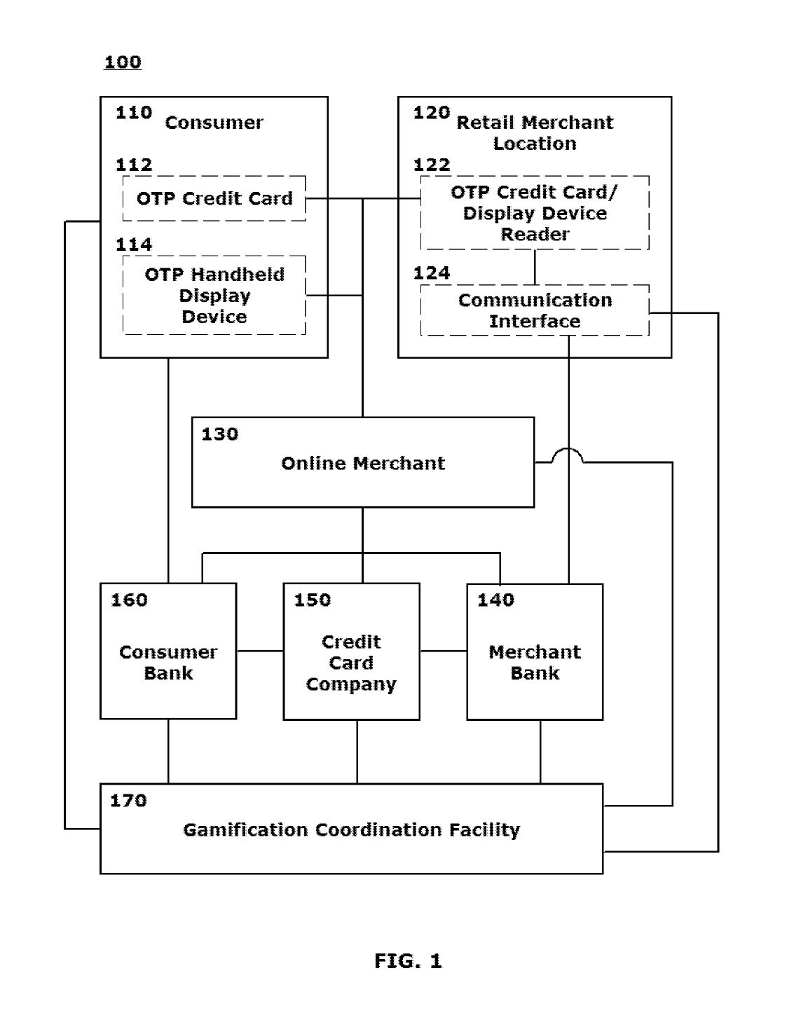

FIG. 1 illustrates a block diagram of an exemplary transactive environment 100 within which the gamified OTP schemes according to this disclosure may be implemented. As shown in FIG. 1, the exemplary environment 100 may include a consumer (or customer) 110 that may employ one or more OTP-enabled transaction vehicles to pay for goods and/or services provided by a retail merchant at a fixed or mobile retail merchant location 120. The OTP-enabled transaction vehicles may be in a form of an OTP credit (or debit) card 112, or an OTP handheld display device 114 that may display a visually discernible transaction enabling image. The consumer 110 may also, or otherwise employ an OTP-enabled transaction vehicle to pay for goods and/or services purchased from an online merchant 130 with whom the consumer 110 communicates via an electronic network, including the Internet.

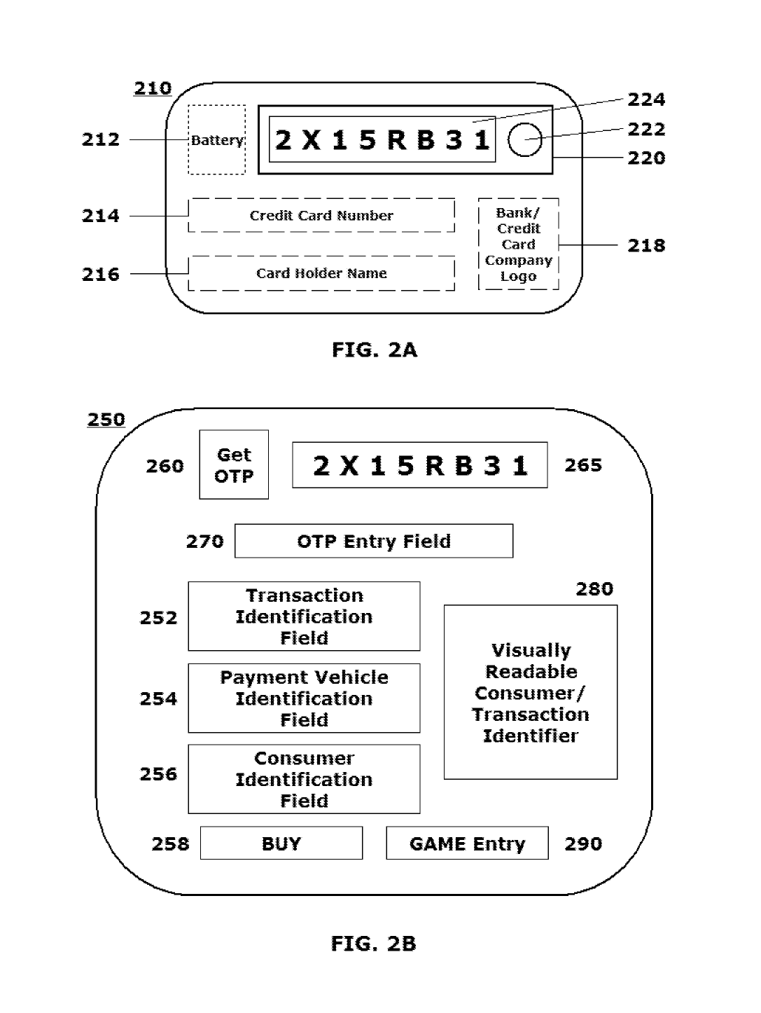

The fixed or mobile retail merchant location 120 may be equipped with an OTP credit card/display device reader 122 that collects the appropriate transaction information including a generated OTP from the particular OTP-enabled transaction vehicle that the consumer 110 chooses to use to complete the transaction. The mechanics of the OTP generation by the consumer-selected OTP-enabled transaction vehicle will be described in greater detail below with respect to FIGS. 2A and 2B. Once the OTP credit card/display device reader 122 collects the transaction information, including consumer and account identifying information, and the OTP from the consumer's OTP-enabled transaction vehicle, the retail merchant location 120 may communicate the transaction information to its merchant bank 140 for processing and approval, often in conjunction/coordination with an issuing credit card company 150. Similar processing and communication will be undertaken by the online merchant 130. Depending on the equipment available to the consumer 110 by which to make online purchases, the consumer 110 may have to manually enter requested transaction information, including the OTP, from the OTP-enabled transaction vehicle to an electronic fillable form provided by the online merchant 130, for example, on its Website.

According to conventional transaction processing, the OTP-supported transactions may be coordinated, approved, and billed by the merchant bank 140, the credit card company 150 and the consumer bank 160. As shown further in FIG. 1, each of the entities involved in any OTP-supported transaction may communicate with a gamification coordination facility 170 that may provide the mechanism for by which to implement the disclosed gamified incentivization scheme involving the consumer or customer use of OTP-enabled transaction vehicles.

The disclosed schemes encompass both direct and indirect gamification of the OTP transaction process, via Reactive or traditional means, so that the consumer 110, the merchant location 120 and/or the online merchant 130 experience rewards and positive emotions whenever OTP-enable transactions are processed. A contest host, as a gamification coordination facility 170, may create a contest on a recurringly scheduled basis, i.e. each hour, each day, each week or on any other predetermined schedule. In these specified contest time frame windows, consumers and merchants who use and accept OTP-enabled transaction vehicles, can enter the generated OTPs according to a manual or automated scheme to compete with others to win cash and prizes, or be eligible to enter a contest or sweepstakes where cash and prizes are available to be awarded to participants. Prizes may be awarded as, and participants may be notified of, the results of a contest in which winners are identified when all or a portion of their entered OTP generated in a transaction (modified as appropriate by layered security) matches number(s) chosen by the gamification coordination facility 170.

The contest host and/or gamification coordination facility 170 may be one or more of the parties involved in the OTP-card industry and/or OTP enable transaction, including the merchant bank 140, the credit card company (or network) 150, the consumer bank 160 or other entity such as the merchants, in retail locations or online and other specified OTP-transaction vehicle issuers.

In an embodiment, a consumer 110 may receive, from the gamification coordination facility 170, an “Entry Notification,” via email, native app, Website posting, SMS, telephone message, printed mail, broadcast/webcast alert or other means, of each authorized and confirmed transaction using their OTP-enabled transaction vehicles. The entry Notification may include the OTP generated, optionally hashed by an additional password provided by the consumers, and verification of their entry into the OTP-enabled contest. An additional reward or prize pool may be awarded to consumers and merchants who participate in OTP-enabled contests that use the additional layers of security and passwords for their transactions.

A Follow-up Results Notice from the gamification coordination facility 170 (via the same or different communication medium) may inform the consumer 110 of a result of the contest, and instruct select winning consumers 110, for example, on how to redeem their prizes.

Winning number may be a simple random drawing conducted by the contest host or a party engaged by the contest host, where a match would result in a prize being awarded. Alternatively, the winning number may include some combination of the OTP, a time stamp, a geographic location of the transaction, e.g. in the form of a latitude and longitude of a centroid, or a zip code, a transaction amount, a transaction type, and/or a component of the consumer's or merchant's data. Any of these data filtering components could be employed to reduce the odds of a tie, or a winning number may be matched only during a prescribed contest period (contest time frame window). The scheme may include a prize filter by which the less likely that a match is generated, the higher the value of a potential prize that may be awarded. For example, the OTP generated by an OTP-enabled transaction vehicle may be 345678, and a password entered by user may be 1429, and the time the OTP is generated may be 10:45:23 EST on Jun. 16, 2016. These data points may be incorporated and further “hashed” to create a unique and secure final “entry” number that cannot be directly tied to the OTP generated on the OTP-enabled transaction vehicle.

In another embodiment, a Reactive version of the contest may provide the consumer 110 with an entry to a contest, sponsored by an advertiser, not necessarily related to the contest host or the gamification coordination facility 170, or to the credit card company 150, the merchants or the banks. The advertisers may present marketing materials for example via one or more of (1) the Entry Notification, or (2) as a link to the marketing materials (in online, mobile or fixed physical locations, where a Reactive game is presented, as described in the 745 Patent, and where correctly answering some or all of the questions presented to an invitee to the Reactive game, and/or responding or reacting to queries, provides an opportunity to win a prize by a winner among a selectively chosen group of consumers gaining first entry to the game space based on their use of their OTP-enabled transaction vehicle in completing a transaction. The winning prizes (or valued items) may include tangible prizes, cash, discounts, coupons, early access to purchase an item, samples, free or discounted entertainment content, or other privilege deemed valuable by consumers.

In another embodiment, the merchant who processes the winning OTP transaction may separately receive one or more of the following: direct remuneration in the form of cash, discounted services, waiver of some or all of merchant fees for a period of time, advertising promotion, donations made to charities selected by the merchant or its customers/employees, payments to merchant employees, access to discounted or free reactive ad campaigns, positive Public Relations and advertising, or further rewards to the consumer who generated the winning OTP.

FIG. 2A illustrates a block diagram of an exemplary OTP-enabled credit card 210 as an example of an OTP-enabled physical transaction token that is usable in the gamified scheme according to this disclosure.

As shown in FIG. 2A, the exemplary OTP-enabled credit card 210 may include many of the same identifying features that are provided on conventional credit cards. These may include, for example, an indication of a credit card number 214, an indication of the cardholder's name 216 and/or a bank/credit card company logo 218. What differentiates the exemplary OTP-enabled credit card 210 from a conventional credit card is the inclusion of a battery 212 that powers the exemplary OTP-enabled credit card 210, and particularly the OTP generating device 220. The OTP generating device 220 may include an activation button 222 and an OTP display window 224. In the example shown in FIG. 2A, the OTP display window 224 may be configured to display, for example, an eight character alpha-numeric OTP. It should be noted that the depiction of the exemplary OTP-enabled credit card 210 in FIG. 2A is done for illustration purposes only. There is, for example, virtually no restriction on the composition and/or configuration of the individual identification components and/or OTP generating device 220 and no such limitations should be inferred from the depiction in FIG. 2A.

FIG. 2B illustrates a block diagram of an exemplary OTP-enabled visually-readable display component 250 as an example of an OTP-enabled electronic display device that is usable in the gamified scheme according to this disclosure.

As shown in FIG. 2B, the exemplary OTP-enabled visually-readable display component 250 may include many of the same identifying features that are provided on conventional electronic transaction displays. These may include, for example, a transaction identification field 252 that captures the details of the transaction, a payment vehicle identification field 254 that captures the details of the payment vehicle, and a consumer identification field 256 that captures the details of the individual consumer executing the transaction. There is a transaction execution or “BUY” button 258 by which once all of the other fields are correctly populated, the transaction may be executed. Again here, there are details captured in the display to differentiate the exemplary OTP-enabled visually-readable display component 250 from the conventional electronic transaction display. The details include the components of an OTP generating device being included in the display. These components may include an activation button or “Get OTP” button 260 and an OTP display field (or window) 265. In the example shown in FIG. 2B, the OTP display field 265 window 224 may be configured to display, for example, an eight character alpha-numeric OTP. The exemplary OTP-enabled visually-readable display component 250 may then include, as one of the transaction fields, an OTP entry field 270 by which the user enters the generated OTP shown in OTP display field 265 in the ODP entry field 270 4 inclusion as part of the transaction information prior to executing the transaction by hitting the “BUY” button 258.

The exemplary OTP-enabled visually-readable display component 250 may include a field that displays a visually readable consumer/transaction identifier 280. Such an identifier 280 may be employed to provide to an NFC reader using visual cues in machine-readable non-human decipherable indication of all of the details of the transaction including, for example, the identification of the transaction, the payment vehicle, the consumer and the entered OTP.

It is envisioned that a consumer's entry into a game, contest, or sweepstakes using an OTP-enabled credit card 210 will be signaled simply by selecting the credit card in a compatible card reader. The consumer may be offered the opportunity to accept or decline game entry by manipulating one or more buttons on the compatible card reader. In a case where the OTP-enabled transaction vehicle is the exemplary OTP-enabled visually-readable display component 250 shown in FIG. 2B, game entry may be implemented by simply manipulating the transaction completion or “BUY” button 258. Otherwise, game entry may be signaled by the user manipulating a separate button associated only with the game such as the “GAME Entry” button 290 shown in FIG. 2B.

As with the exemplary OTP-enabled credit card 210 shown in FIG. 2A, the depiction of the exemplary OTP-enabled visually-readable display component 250 in FIG. 2B is done for illustration purposes only. There is, for example, virtually no restriction on the composition and/or configuration of the individual display fields, OTP generating complements, transaction execution complements and/or visually readable consumer/transaction identifier fields, and no such limitations should be inferred from the depiction in FIG. 2B.

When an OTP-enabled transaction vehicle is used in the transaction, the OTP is seen by the consumer and entered into an online/computer form or on-premises key pad or kiosk, or other data entry device, such as a mobile phone payment. The “unique” number is then validated, tied to the user (either directly or indirectly through means including data incorporated into the credit card transaction display component, which is hashed or otherwise used to create the OTP). The transaction event may be time stamped and a geo-location of the consumer when executing the transaction event may be recorded. Additional layers of security (including a password known only by the consumer) may be entered to unlock the OTP-enabled credit card 210 or OTP-enabled visually-readable display component 250, or to generate a final “contest entry” ID number that is then reported to the identification coordination facility or contest host.

An OTP itself may include four or more numbers or alpha-numeric characters and may be submitted in a very similar manner to an entry number in a raffle or game of chance. An eight digit number can be presented in nearly 100 million unique ways; a 6-digit number in nearly 1,000,000 unique ways. For perspective, there are approximately 55 million credit card transactions each day in the U.S. In other words, there are less daily transactions than there are unique eight-digit OTPs (assuming, even, that each transaction generated an OTP). As a result, a daily random drawing from all OTPs generated (even before hashing), and awarding of a prize to the consumer whose OTP-enabled transaction device may have generated the OTP (and also, optionally or additionally, to the merchant who conducted the transaction in which the OTP was used) would not result in a likely match on any given day. Without hashing outside the OTP itself, the likelihood (using the above numbers) would be approximately 55%, even assuming each transaction utilized an OTP-enabled transaction vehicle (55 million transactions/100 million unique digits). The selection of “winning” OTPs may result in multiple consumers (and multiple merchants) being selected. In such an instance, based upon the level of randomness and numbers generated as OTPs, and the number of OTP-enabled transaction vehicles using OTPs in their transactions, some allowance for “multiple” (or “tied”) winners could be taken into consideration. Using actuarial analysis, the prize pool, for example, could be created so that is would result in tied winners each obtaining the same prize (with the individual prize values being diminished to account for ties, such that a pre-determined prize pool value could be derived with some certainty by the contest hosts operating the identification coordination facilities). Alternatively, an overall prize pool could be divided among all winners (similar to how some state lotteries operate). Other variations may include a tie-breaker of some sort, which could include a contest between finalists, an algorithm linked to the transaction value, creating a “poker hand” from the OTP, a tie-breaker question, awarding prizes based on transactions occurring earlier or later in the contest timeframe window, or closer to a randomly selected time of day, or myriad other means by which luck or skill may be used to select a number of winners less than the number of those who have “winning” numbers.

To accommodate for OTPs being used by different sponsors or card issuers, who wish to use a single aggregated prize pool, and to accommodate OTPs that may be of differing string lengths (i.e. 4-10 digits, varied by card issuer), some method of providing or simulating the perception of fairness between consumers may be developed. This might include utilizing only the first, middle, or last so many digits of the OTPs, which exceed the string length of the selected “winning” OTP. Particularly when multiple card issuers or credit card networks may be issuing OTPs using different algorithms, the likelihood exists of ties occurring between “competing” card issuers, banks, and the like. In such an instance, the prizes to be awarded could be equally divided (as, for example, outlined above), or, a percentage of each contest's prize pool could be divided between “winners” based upon the percentage of entries each competing contest host contributed to that contest period's total entries. Note that where fees are paid by sponsors or contest hosts for each entry, the allocation of the prize pool could be based on the percentage of the prize pool paid for by said sponsors or contest hosts.

Because companies may be reticent to publish actual OTPs via email or other means, a randomized (or assigned unique) number or alpha-numeric code may be assigned to each OTP-enabled transaction. This “alternate” OTP may contain an equal, or a different, number of characters than the actual OPT, could be randomly generated, or drawn from a pool of unique entries so as to avoid ties. In the event a prize pool is part of a single aggregated prize pool (as noted above), the process of selecting winners may also include providing alternate OTPs for some or all entries, so that a third party provider of unique alternate OTPs could be engaged, so as to avoid ties, if such is the desired effect of the sponsors or contest hosts.

The prize award (and cost of conducting, validating, and fulfilling the contest) may be funded by a portion of the cost savings in fraud, and fraud investigation, realized by those in the credit card space. As the popularity of the contest increases, there may logically be more winners, but also more savings in fraud prevention. The prize award and related costs may also be structured so as to be paid for by a contest sponsor, in exchange for that contest sponsor's negotiated access to identification information regarding the participating consumers who may meet certain criteria that coincide with contest sponsor's target audience.

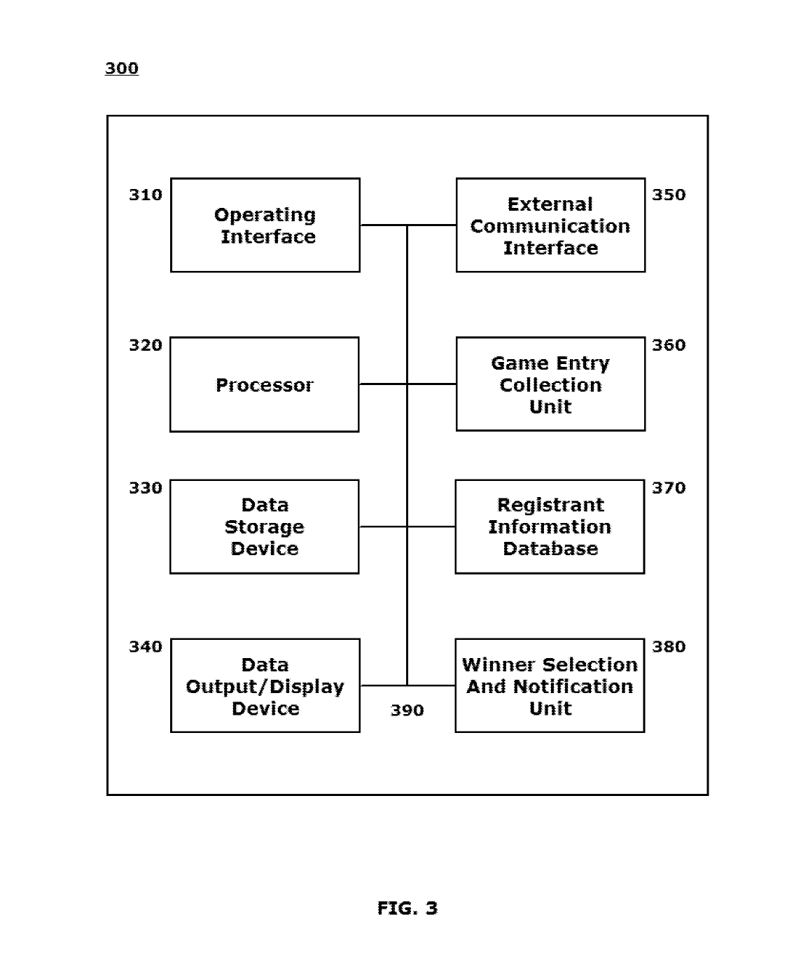

FIG. 3 illustrates a block diagram of an exemplary implementation system 300 that may be housed in a central facility for implementing the gamified scheme according to this disclosure.

The exemplary implementation system 300 may include an operating interface 310 by which a user may communicate with the exemplary implementation system 300. The operating interface 310 may provide a contest host an opportunity to input information appropriate to execution of the contest over a specified period of time and according to one or more filtering parameters for the submitted OTPs. Contests may be arranged according to certain criteria that may be stored in the exemplary implementation system 300 or input via the operating interface 310. These criteria include, but are not limited to arranging contests that are merchant-based, network-based, user social network based, and/or geo-locational, in addition to being time frame based.

The operating interface 310 may be configured as one or more conventional mechanisms common to computing and/or communication devices that may permit a user to input information to the exemplary implementation system 300. The operating interface 310 may include, for example, a conventional keyboard, a touchscreen with “soft” buttons or with various components for use with a compatible stylus, a microphone by which a user may provide oral commands to the exemplary control system 300 to be “translated” by a voice recognition program, or other like device by which a user may communicate specific operating instructions to the exemplary implementation system 300.

The exemplary implementation system 300 may include one or more local processors 320 for individually operating the exemplary implementation system 300 and for carrying into effect the OTP collection and gamification schemes. Processor(s) 320 may include at least one conventional processor or microprocessor that interprets and executes instructions to direct specific functioning of the exemplary implementation system 300, and control of identification scheme carried into effect by the exemplary implementation system 300.

The exemplary implementation system 300 may include one or more data storage devices 330. Such data storage device(s) 330 may be used to store data or operating programs to be used by the exemplary implementation system 300, and specifically the processor(s) 320 in carrying into effect the game application scheme overseen by the exemplary implementation system 300. Data storage device(s) 330 may be used to store information regarding game and/or contest parameters, including any filters by, for example, geographic area, timeframe, transaction type or other like information and to temporarily store the OTPs involved in the current game and to temporarily, or permanently, store consumer identification information. The data storage device(s) 330 may include a random access memory (RAM) or another type of dynamic storage device that is capable of storing updatable database information, and for separately storing instructions for execution of system operations by, for example, processor(s) 320. Data storage device(s) 330 may also include a read-only memory (ROM), which may include a conventional ROM device or another type of static storage device that stores static information and instructions for processor(s) 320. Further, the data storage device(s) 330 may be integral to the exemplary implementation system 300, or may be provided external to, and in wired or wireless communication with, the exemplary implementation system 300, including as cloud-based storage components.

The exemplary implementation system 300 may include at least one data output/display device 340, which may be configured as one or more conventional mechanisms that output information to a user. The data output/display device 340 may be used to indicate to a user such as, for example, a contest host, a status of an in-process game or contest. The data output/display device 340 may be used to display identification information of a consumer associated with the selected winning OTP, and to afford the user an opportunity to manually intervene in the winner notification process.

The exemplary implementation system 300 may include one or more separate external communication interfaces 350 by which the exemplary implementation system 300 may communicate with the other transaction components external t is, and in communication with, the exemplary implementation system 300. At least one of the external communication interfaces 350 may be configured as an input port by which the exemplary implementation system 300 may receive OTP transaction information, and OTPs from merchants, banking institutions, and/or credit card companies. At least one of the external communication interfaces 350 may be configured as an output port by which a winning consumer may be notified.

The exemplary implementation system 300 may include an entry collection unit 360 that may be used to collect OTPs from various sources for use in a current game. The received OTPs may come from any of the entities involved in collecting information regarding, authorizing, approving and/or reporting on OTP-enabled transactions.

The exemplary implementation system 300 may include a registrant information database 370 in which consumer identification information associated with the collected OTPs may be captured and stored.

The exemplary implementation system 300 may include a winner selection notification unit 380. The winner selection and notification unit 380 may operate as a part of the processor 320 coupled to, for example, one or more data storage devices 330, or as a separate stand-alone component module or circuit in the exemplary implementation system 300. The winner selection notification unit 380 may apply an algorithm and certain filtering to the collected OTPs to parse those OTPs that are actually part of the contest. According to some criteria, a winning OTP may be selected or otherwise generated for comparison to the population of collected OTPs participating in a particular contest. Upon identifying a winning OTP from among the collected OTPs the winner selection notification unit 380 may reference stored consumer identification information associated with the winning OTP and generate some form of winner notification, which may include instructions for prize redemption.

All of the various components of the exemplary implementation system 300, as depicted in FIG. 3, may be connected internally, and to one or more entities in the OTP-enabled transactions based, by one or more data/control busses 390. These data/control busses 390 may provide wired or wireless communication between the various components of the exemplary implementation system 300, whether all of those components are housed integrally in, or are otherwise external and connected to gamification coordination facility.

It should be appreciated that, although depicted in FIG. 3 as an essentially integral unit, the various disclosed elements of the exemplary implementation system 300 may be arranged in any combination of sub-systems as individual components or combinations of components, integral to a single unit, or external to, and in wired or wireless communication with the single unit of the exemplary implementation system 300. In other words, no specific configuration as an integral unit or as a support unit is to be implied by the depiction in FIG. 3. Further, although depicted as individual units for ease of understanding of the details provided in this disclosure regarding the exemplary implementation system 300, it should be understood that the described functions of any of the individually-depicted components may be undertaken, for example, by one or more processors 320 connected to, and in communication with, one or more data storage device(s) 330.

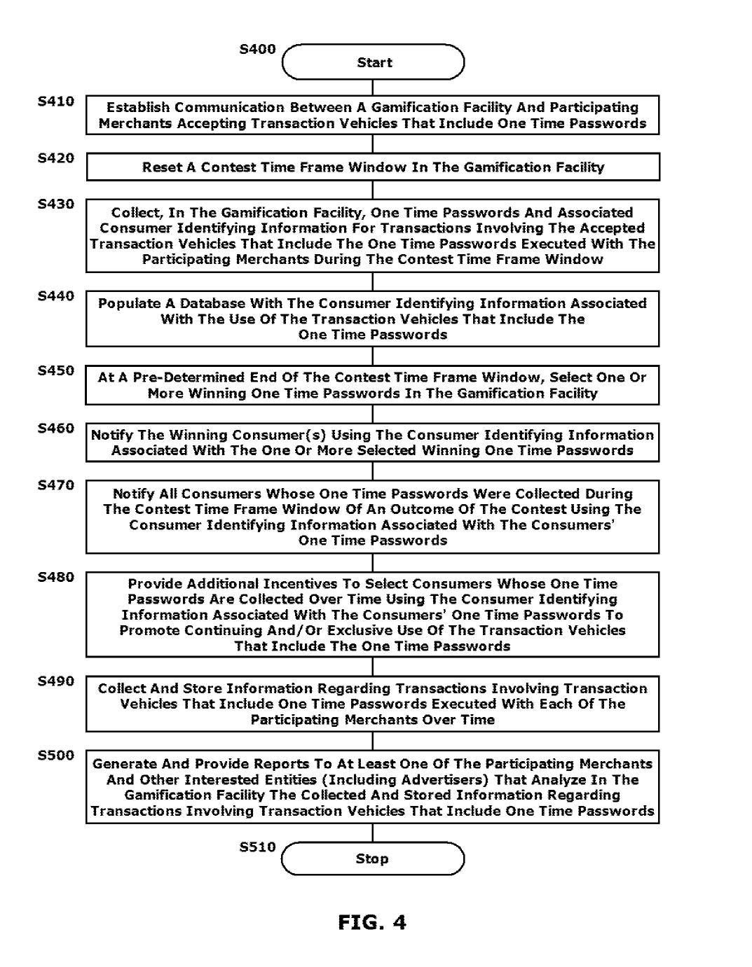

The disclosed embodiments may include an exemplary method for implementing the gamified scheme involving the consumer use of OTP-enabled transaction vehicles. FIG. 4 illustrates a flowchart of such an exemplary method. As shown in FIG. 4, operation of the method commences at Step S400 and proceeds to Step S410.

In Step S410, communication may be established between a gamification facility and participating merchants accepting transaction vehicles that include OTPs. Operation of the method proceeds to Step S420.

In Step S420, a contest time frame window may be reset in the gamification facility to establish a “new” contest. Operation of the method proceeds to Step S430.

In Step S430, OTPs and associated consumer identifying information may be collected in the gamification facility for transactions involving the accepted transaction vehicles that include the OTPs executed with the participating merchants during the contest time frame window. Operation of the method proceeds to Step S440.

In Step S440, a database may be populated with consumer identifying information associated with the use of the transaction vehicles that include the OTPs. Operation of the method proceeds to Step S450.

In Step S450, and a predetermined end of the contest timeframe window, one or more winning OTPs may be selected in the gamification facility. Operation of the method proceeds to Step S460.

In Step S460, when consumers may be notified using the consumer identify buying information associated with the one or more a selected winning OTPs. Operation of the method proceeds to Step S470.

In Step S470, all consumers whose OTPs were collected during the contest timeframe window may be notified of an outcome of the contest using the consumer identifying information associated with the consumers' OTPs. Operation of the method proceeds to Step S480.

In Step S480, additional incentives to select consumers whose OTPs are collected over time may be provided using the consumer identifying information associated with the consumers' OTPs to promote continuing and/or exclusive use of the transaction vehicles that include the OTPs. Operation of the method proceeds to Step S490.

In Step S490, information regarding transactions involving transaction vehicles that include OTPs executed with each of the participating merchants over time may be collected and stored. Operation of the method proceeds to Step S500.

In Step S500, reports may be generated and provided to at least one of the participating merchants and/or other interested entities (including advertisers) that analyze, in the notification facility, the collected and stored information regarding transactions involving transaction vehicles that include OTPs. Operation of the method proceeds to Step S5100, where operation of the method ceases.

The disclosed embodiments may include a non-transitory computer-readable medium storing instructions which, when executed by a processor, may cause the processor to execute all, or at least some, of the steps of the method outlined above.

The above-described exemplary systems and methods reference certain conventional components to provide a brief, general description of suitable operating, transaction processing and identification scheme implementing environments in which the subject matter of this disclosure may be undertaken for familiarity and ease of understanding. Although not required, embodiments of the disclosure may be provided, at least in part, in a form of hardware circuits, firmware, or software computer-executable instructions to carry out the specific functions described. These may include individual program modules executed by processors.

Those skilled in the art will appreciate that other embodiments of the disclosed subject matter may be practiced in myriad transactions involving a broad spectrum of transaction participants in the OTP-enabled transaction space.

As indicated above, embodiments within the scope of this disclosure may include computer-readable media storing computer-executable instructions or data structures that can be read and executed by one or more processors for controlling the OTP gamification process. Such computer-readable media can be any available media that can be accessed by a processor, general purpose or special purpose computer. By way of example, and not limitation, such computer-readable media can comprise RAM, ROM, EEPROM, CD-ROM, flash drives, data memory cards or other analog or digital data storage device that can be used to carry or store desired program elements or steps in the form of accessible computer-executable instructions or data structures.

Computer-executable instructions include, for example, non-transitory instructions and data that can be executed and accessed respectively to cause a processor to perform certain of the above-specified functions, individually or in various combinations. Computer-executable instructions may also include program modules that are remotely stored for access and execution by a processor.

The exemplary depicted sequence of executable instructions or associated data structures represent one example of a corresponding sequence of acts for implementing the functions described in the steps of the above-outlined exemplary method. The exemplary depicted steps may be executed in any reasonable order to carry into effect the objectives of the disclosed embodiments. No particular order to the disclosed steps of the method is necessarily implied by the depiction in FIG. 4, except where a particular method step is a necessary precondition to execution of any other method step.

Although the above description may contain specific details, they should not be construed as limiting the claims in any way. Other configurations of the described embodiments of the disclosed systems and methods are part of the scope of this disclosure.

It will be appreciated that various of the above-disclosed and other features and functions, or alternatives thereof, may be desirably combined into many other different systems or applications. Also, various alternatives, modifications, variations or improvements therein may be subsequently made by those skilled in the art which are also intended to be encompassed by the following claims.

We claim:

1. A system for facilitating financial transactions, comprising:
a communication component that communicates with at least one of (1) merchants executing financial transactions and (2) administrators executing access transactions, each transaction involving at least one of a user transaction token or user transaction data that includes a temporary passcode that is generated at the time of each transaction as a data element used in an authorization process for the transaction;
a data collection device that collects the temporary passcode generated for each transactions and associated user identifying information;
a data storage device that stores the collected temporary passcodes and the associated user identifying information;
a gaming device that designates one or more of the users as award recipients using the collected temporary passcodes; and
a notification device that generates an award notification and forwards is to each of the designated one or more award recipients.

2. The system of claim 1, the financial transactions involving user transaction tokens that are powered credit cards.

3. The system of claim 2, the temporary passcode being generated by a user activating a temporary passcode generating component on a face of the powered credit card.

4. The system of claim 3, the temporary passcode being entered by the user at a credit card reader device when the powered credit card is read by the credit card reader device.

5. The system of claim 1, at least one of the temporary passcode and the associated user identification information being read by a no-touch near field communication device operated by the at least one of the merchant and administrator

6. The system of claim 1, further comprising a gaming entry generating device that modifies the temporary passcode by applying other information to the temporary passcode to mask the actual constitution of the temporary passcode to add a level of security to the collected temporary passcodes.

7. The system of claim 1, the associated user identifying information excluding all user financial transaction account information or user authorization account information associated with the user transaction token or user transaction data.

8. The system of claim 1, the data storage device applying one or more filtering criteria that allow the gaming device to consider only filtered ones of the temporary passcodes for designating the one or more users as an award recipient.

9. The system of claim 8, the one or more filtering criteria limiting the designating of the one or more users as award recipients including temporary passcodes generated for financial transactions undertaken (1) by specified merchants, (2) by specified administrators, (3) over specified networks, (4) via specified user social networks, (5) in specified geographic locations or (6) during specified time frames.

10. The system of claim 1, the gaming device designating the one or more of the users as award recipients by selecting from among the collected temporary passcodes.

11. The system of claim 1, the gaming device designating the one or more of the users as award recipients by generating a gaming device temporary passcode and comparing the gaming device temporary passcode to the collected temporary passcodes to determine whether there is a matching collected temporary passcode.

12. A method for facilitating financial transactions, comprising:
establishing communications, via a communication network, with at least one of (1) merchants executing financial transactions and (2) administrators executing access transactions, each transaction involving at least one of a user transaction token or user transaction data that includes a temporary passcode that is generated at the time of the transaction as a data element used in an authorization process for the transaction;
collecting, with a processor, the temporary passcode generated for each transaction and associated user identifying information;
storing, in a data storage device, the collected temporary passcodes and the associated user identifying information;
designating, with the processor, one or more of the users as award recipients using the collected temporary passcodes; and
generates, with the processor, an award notification and forwarding, via the communication network, the generated award notification to each of the designated one or more award recipients.

13. The method of claim 12, the financial transactions involving user transaction tokens that are powered credit cards, the temporary passcode being generated by a user activating a temporary passcode generating component on a face of the powered credit card, and entered by the user at a credit card reader device when the powered credit card is read by the credit card reader device.

14. The method of claim 12, at least one of the temporary passcode and the associated user identification information being read by a no-touch near field communication device operated by the at least one of the merchant and administrator.

15. The method of claim 12, further comprising modifying, with the processor, the temporary passcode by applying other information to the temporary passcode to mask the actual constitution of the temporary passcode to add a level of security to the collected temporary passcodes.

16. The method of claim 12, further comprising parsing, with the processor, the associated user identifying information to exclude all user financial transaction account information or user authorization account information associated with the user transaction token or user transaction data.

17. The method of claim 12, further comprising applying, with the processor, one or more filtering criteria that allow the gaming device to consider only filtered ones of the temporary passcodes for designating the one or more users as an award recipient,
the one or more filtering criteria limiting the designating of the one or more users as award recipients including temporary passcodes generated for financial transactions undertaken (1) by specified merchants, (2) by specified administrators, (3) over specified networks, (4) via specified user social networks, (5) in specified geographic locations or (6) during specified time frames.

18. The method of claim 12, the designating the one or more of the users as award recipients comprising selecting from among the collected temporary passcodes.

19. The method of claim 12, the designating the one or more of the users as award recipients comprising generating, with the processor, a system temporary passcode, and comparing, with the processor, the generated system temporary passcode to the collected temporary passcodes to determine whether there is a matching collected temporary passcode.

20. A non-transitory computer readable medium storing instructions that, when executed by a processor, cause the processor to execute the steps of a method for facilitating financial transactions, comprising:
communicating with at least one of (1) merchants executing financial transactions and (2) administrators executing access transactions, each transaction involving at least one of a user transaction token or user transaction data that includes a temporary passcode that is generated at the time of each transaction as a data element used in an authorization process for the transaction;
collecting the temporary passcode generated for each of the financial transactions and associated user identifying information;
storing the collected temporary passcodes and the associated user identifying information;
designating one or more of the users as award recipients using the collected temporary passcodes; and
generating and forwarding award notification to each of the designated one or more award recipients.
